(19) United States
(12) Patent Application Publication
(10) Pub. No.: US 2026/0339026 A1
(43) Pub. Date: Oct. 29, 2026

(54) OPTICAL DEVICE AND METHOD OF MANUFACTURE

(71) Applicant: Taiwan Semiconductor Manufacturing Co., Ltd., Hsinchu (TW)

(72) Inventors: Su-Chun Yang, Hsinchu (TW); Jih-Churng Twu, Hsinchu (TW); Yutong Wu, Hsinchu City (TW); Chih-Ming Ke, Hsinchu (TW); Chung-Shi Liu, Hsinchu (TW); Chen-Hua Yu, Hsinchu (TW)

(21) Appl. No.: 19/727,767

(22) Filed: Jul. 1, 2026

Related U.S. Application Data
(62) Division of application No. 18/437,960, filed on Feb. 9, 2024.

(51) Int. Cl. G02B 6/125; G02B 6/13

(52) U.S. Cl. CPC G02B 6/125; G02B 6/13

(57) ABSTRACT

Optical devices and methods of manufacturing the optical devices are provided. In an embodiment, an optical device includes a first insulating layer over a substrate and a first waveguide in the first insulating layer. The first waveguide includes a first major portion and a first bent portion extending upwardly from the first major portion away from the substrate. The optical device also includes a second waveguide over the first waveguide, and the second waveguide includes a second major portion over the first insulating layer and a second bent portion extending downwardly from the second major portion and into the first insulating layer.

### PRIORITY CLAIM AND CROSS-REFERENCE

This application is a divisional of U.S. patent application Ser. No. 18/437,960, filed on Feb. 9, 2024, which application is hereby incorporated herein by reference.

### BACKGROUND

Electrical signaling and processing are one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1 to 9 illustrate cross-sectional views at intermediate stages of manufacturing an optical interconnect structure, in accordance with some embodiments.

FIGS. 10 to 14 illustrate cross-sectional views at intermediate stages of manufacturing an optical interconnect structure, in accordance with some embodiments.

FIGS. 15 to 21 illustrate cross-sectional views at intermediate stages of manufacturing an optical interconnect structure, in accordance with some embodiments.

FIG. 22 illustrates a cross-sectional view of an optical interconnect structure, in accordance with some embodiments.

FIGS. 23 to 25 illustrate cross-sectional views at intermediate stages of manufacturing a photonic integrated circuit, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be described with respect to a particular embodiment of an optical interconnect structure that includes multiple levels of optical waveguides. In some embodiments of the present disclosure, the optical waveguide has one or more bent portions that can extend upwardly or downwardly from a major portion of the optical waveguide. Accordingly, the optical waveguides in different levels may be coupled by making their bent portions close to each other. Vertical optical interconnects may thus be provided. However, the embodiments presented herein are intended to be illustrative of the ideas presented, and are not intended to be limiting.

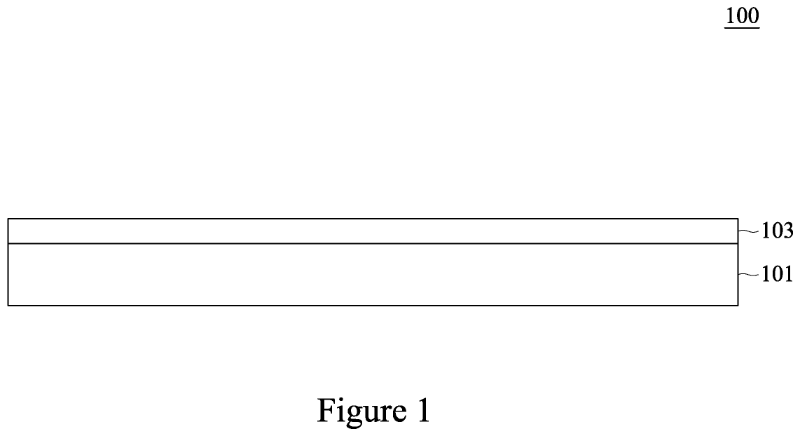

FIGS. 1 to 9 illustrate cross-sectional views at intermediate stages of manufacturing an optical interconnect structure 100, in accordance with some embodiments. With reference to FIG. 1, there is illustrated an initial structure of a substrate 101 with a first insulating layer 103 formed over the substrate 101, which are first steps in the formation of the optical interconnect structure 100. Looking first at the substrate 101, the substrate 101 may include bulk silicon, doped or undoped, or an active layer of a silicon-on-insulator (SOI) substrate. Generally, an SOI substrate includes a layer of a semiconductor material such as silicon, germanium, silicon germanium, SOI, silicon germanium on insulator (SGOI), or combinations thereof. Other substrates that may be used include multi-layered substrates, gradient substrates, or hybrid orientation substrates. Additionally, the substrate 101 at this point in the process may be part of a semiconductor wafer (the full wafer of which is not illustrated in FIG. 1) that will be singulated in a later step.

In an embodiment the first insulating layer 103 may be a cladding material and/or dielectric layer such as silicon oxide, silicon nitride, germanium oxide, germanium nitride, combinations of these, or the like, formed using a deposition method such as thermal oxidation, a plasma enhanced chemical vapor deposition, other chemical vapor deposition processes, physical vapor deposition, combinations of these, or the like. However, any suitable material and method of manufacture may be utilized.

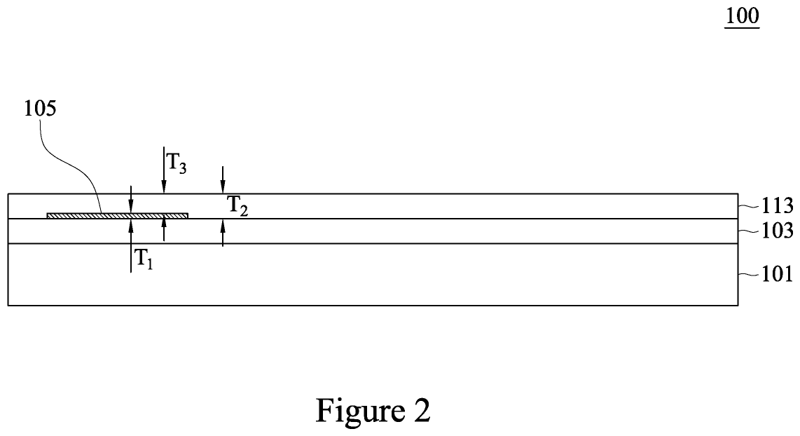

With reference to FIG. 2, once the first insulating layer 103 has been formed, a first waveguide 105 may be formed over the first insulating layer 103. In an embodiment the first waveguide 105 may be any suitable type of waveguide (e.g., ridge waveguides, rib waveguides, buried channel waveguides, diffused waveguides, etc.) and may be formed by initially depositing a core material such as silicon nitride, a-silicon (amorphous Si), AlN, Al₂O₃, Ta₂O₅, combinations of these, or the like using a deposition method such as chemical vapor deposition, physical vapor deposition, atomic layer deposition, combinations of these, or the like to a thickness T₁ of between about 0.1 μm and about 1 μm. Once a core material has been deposited over the first insulating layer 103, the core material is patterned into the designed shape for the first waveguide 105 using, e.g., a photolithographic masking and etching process. However, any suitable materials, thicknesses, and methods of manufacture may be utilized. The first waveguide 105 may include a narrowed width of between about 1 nm and about 200 nm, etc. In some embodiments, the first waveguide 105 may include a gradually narrowed width toward an end of the first waveguide 105 in a top view.

After the first waveguide 105 has been formed, a second insulating layer 113 is formed over the first waveguide 105. In an embodiment the second insulating layer 113 may be formed using similar materials and methods of formation as the first insulating layer 103 described above, such as depositing a material such as silicon oxide using a deposition method such as a low temperature plasma enhanced chemical vapor deposition. However, any suitable materials and methods of manufacturing may be utilized. In some embodiments, the second insulating layer 113 has a thickness T₂ of about 1 to about 30 μm. A thickness T₃ between an upper surface of the first waveguide 105 and an upper surface of the second insulating layer 113 may be about 0.9 to about 29.9 μm.

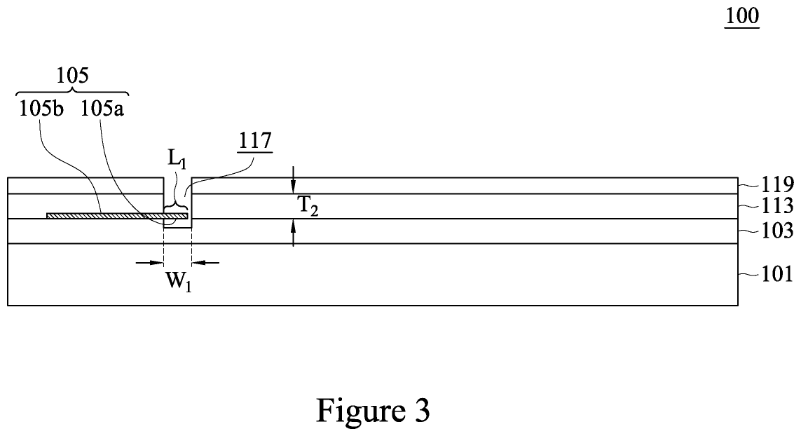

With reference to FIG. 3, after the second insulating layer 113 has been formed, a recess 117 is formed to expose an end portion 105a of the first waveguide 105. A major portion 105b of the first waveguide 105 remains covered by the second insulating layer 113. In some embodiments, the end portion 105a of the first waveguide 105 has a length L₁. The length L₁ may be greater than a half of the thickness T₂ of the second insulating layer 113, or may be equal to or greater than the thickness T₂ of the second insulating layer 113. For example, the length L₁ may be about 1 μm to about 30 μm. The recess 117 may have a width W₁ greater than the length L₁ and extend to a depth deeper than the bottom of the first waveguide 105 to allow the end portion 105a of the first waveguide 105 to be free to move in subsequent processes. Because the material of the first waveguide 105, such as silicon nitride or other materials described above, is rigid, the end portion 105a of the first waveguide 105 may hang in the recess 117.

In some embodiments, the recess 117 may be formed by etching the second insulating layer 113 and the first insulating layer 103 according to a pattern of a mask layer 119. For example, the formation of the mask layer 119 may include depositing a mask material over the second insulating layer 113 by any suitable deposition process and patterning the mask material to form the pattern in the mask layer 119 by any suitable patterning processes. The mask layer 119 may be a hard mask such as titanium nitride, silicon nitride, silicon oxynitride, silicon carbide, other suitable materials, or a combination thereof. Alternatively, the mask layer may be a photoresist material. The etch process for forming the recess 117 may include a wet etch process or a combination of a dry etch process followed by a wet etch process, with using an etchant comprising fluorine (e.g., HF, CF₃, C₂F₂, or the like). The etch process may have a high selectivity for the second insulating layer 113 and the first insulating layer 103 relatively to the first waveguide 105.

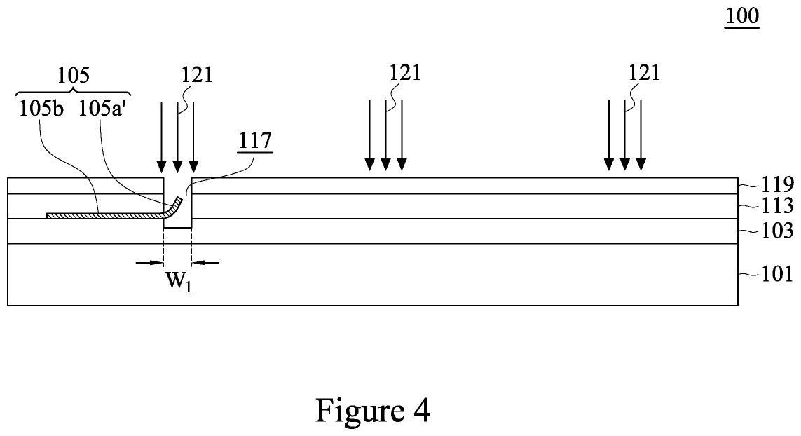

With reference to FIG. 4, after the end portion 105a of the first waveguide 105 is exposed from recess 117, an implant process 121 is performed on the end portion 105a of the first waveguide 105, in accordance with some embodiments. Other portions of the first waveguide 105 such as the major portion 105b are masked by the mask layer 119 while performing the implant process 121. The implant process 121 may include implanting first implant species into the end portion 105a of the first waveguide 105. The first implant species may include nitrogen ions (N⁺), silicon ions (Si⁺), other suitable ions, or a combination thereof. The first implant species may be delivered using an ion beam having a dose from about 1×10¹⁴ atoms/cm² to about 1×10¹⁶ atoms/cm², with implant energy from about 100 keV to about 150 keV at a temperature of about −30 degrees Celsius to about 200 degrees Celsius. An anneal process may not be needed after the implant process 121.

In some embodiments, the depth of peak concentration of the first implant species in the end portion 105a of the first waveguide 105 may be well-controlled by the implant process 121. For example, the peak concentration of the first implant species is in the lower half of the end portion 105a of the first waveguide 105, or in the bottom one-third of the end portion 105a of the first waveguide 105. Alternatively, a concentration of the first implant species in the lower half of the end portion 105a of the first waveguide 105 is greater than a concentration of the first implant species in the upper half of the end portion 105a of the first waveguide 105. Accordingly, a compressive stress is generated toward the upper half of the end portion 105a of the first waveguide 105. The end portion 105a of the first waveguide 105 is bent upwardly from the major portion 105b and becomes a bent portion 105a′. In some embodiments, the bent portion 105a′ has a curved shape. The bent portion 105a′ of the first waveguide 105 may extend vertically above a half of the thickness T₃ between the upper surface of the second insulating layer 113 and the upper surface of the major portion 105b of the first waveguide 105. The mask layer 119 for forming the recess 117 may be removed after the implant process 121 is performed by any suitable methods, such as an etch process.

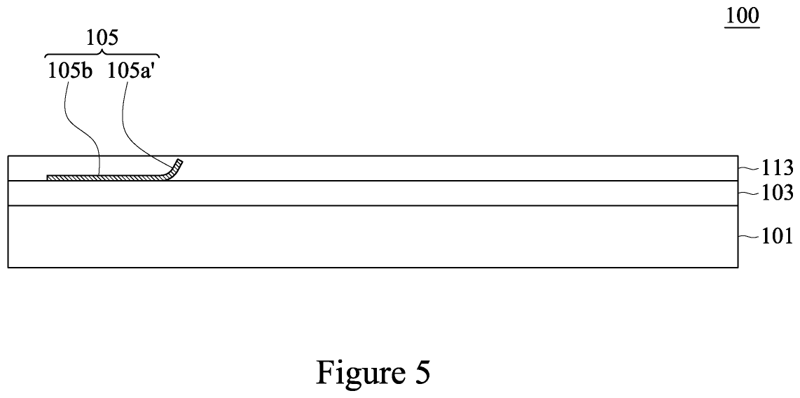

With reference to FIG. 5, after the bent portion 105a′ of the first waveguide 105 has been formed, a deposition process is performed to fill the recess 117, in accordance with some embodiments. The deposition process may provide a material that is the same as the second insulating layer 113 and the first insulating layer 103. Therefore, the second insulating layer 113 after the refill may encapsulate the bent portion 105a′ of the first waveguide 105. The deposition process may include a deposition method such as a plasma enhanced chemical vapor deposition, other chemical vapor deposition processes, physical vapor deposition, combinations of these, or the like. In some embodiments, the mask layer 119 is removed after the deposition process for filling the recess 117 if it is not removed right after the implant process 121. A planarization process such as chemical mechanical polishing (CMP) or mechanical grinding may be optionally performed following the deposition to remove excess materials over the second insulating layer 113.

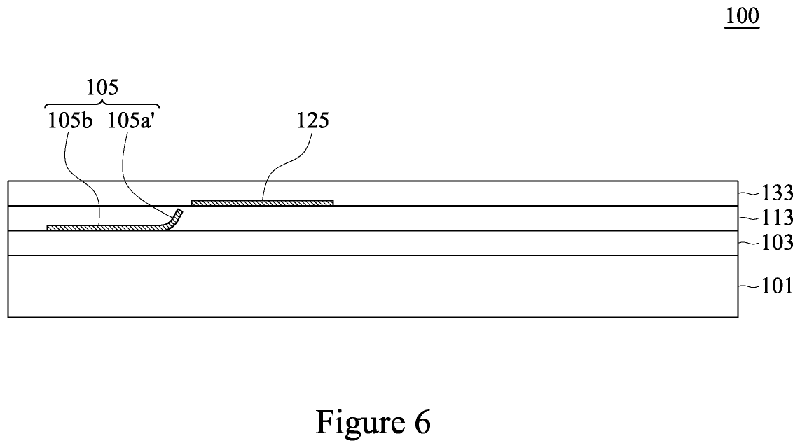

With reference to FIG. 6, a second waveguide 125 may be formed over the second insulating layer 113. In an embodiment the second waveguide 125 may be formed using similar materials and similar methods of manufacture as the first waveguide 105 described above such as depositing a material such as silicon nitride using chemical vapor deposition. However, any suitable materials and methods of manufacturing may be utilized. In some embodiments, the second waveguide 125 has an end adjacent to the bent portion 105a′ of the first waveguide 105. The second waveguide 125 may have a horizontal gap (greater than 0) with the bent portion 105a′ of the first waveguide 105. In some embodiments, the second waveguide 125 includes a narrowed width of between about 1 nm and about 200 nm. For example, the second waveguide 125 includes a gradually narrowed width toward the end adjacent to the first waveguide 105 and/or other ends of the second waveguide 125.

After the second waveguide 125 has been formed, a third insulating layer 133 may be formed over the second waveguide 125 and the second insulating layer 113. In an embodiment the third insulating layer 133 may be formed using similar materials and methods of formation as the first insulating layer 103 described above, such as depositing a material such as silicon oxide using a deposition method such as a low temperature plasma enhanced chemical vapor deposition. However, any suitable materials and methods of manufacturing may be utilized.

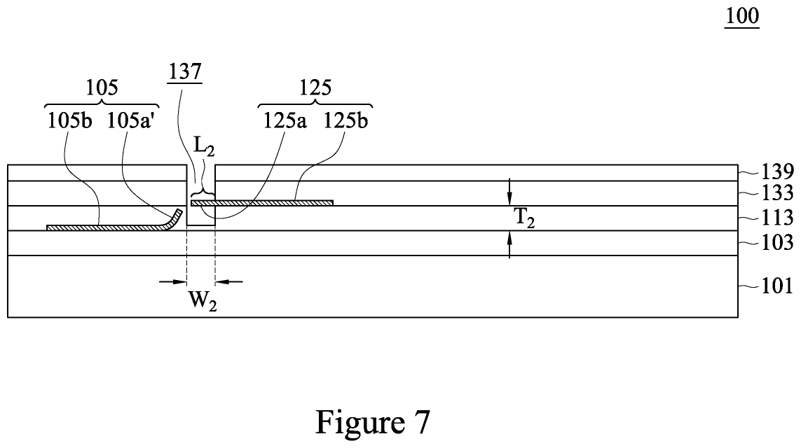

With reference to FIG. 7, after the third insulating layer 133 has been formed, a recess 137 is formed to expose an end portion 125a of the second waveguide 125. A major portion 125b of the second waveguide 125 remains covered by the third insulating layer 133. In some embodiments, the end portion 125a of the second waveguide 125 has a length L₂. The length L₂ may be greater than a half of the thickness of the third insulating layer 133, or may be equal to or greater than the thickness of the third insulating layer 133. For example, the length L₂ may be about 1 μm to about 30 μm. In some embodiments, the length L₂ is the same as the length L₁. Alternatively, the length L₂ may be different from the length L₁. The recess 137 may have a width W₂ greater than the length L₂ and extend to a depth deeper than the bottom of the second waveguide 125 to allow the end portion 125a of the second waveguide 125 to be free to move in subsequent processes. In some embodiments, the depth of recess 137 measured from the upper surface of the second insulating layer 113 is greater than the length L₂. The end portion 125a of the second waveguide 125 may hang in the recess 137.

In some embodiments, the recess 137 may be formed by etching the third insulating layer 133 and the second insulating layer 113 according to a pattern of a mask layer 139. In an embodiment the mask layer 139 may be formed using similar materials and methods of formation as the mask layer 119 described above. However, any suitable materials and methods of manufacturing may be utilized. The etch process for forming the recess 137 may include a wet etch process or a combination of a dry etch process followed by a wet etch process, with using an etchant comprising fluorine (e.g., HF, CF₃, C₂F₂, or the like). The etch process may have a high selectivity for the third insulating layer 133 and the second insulating layer 113 relatively to the second waveguide 125.

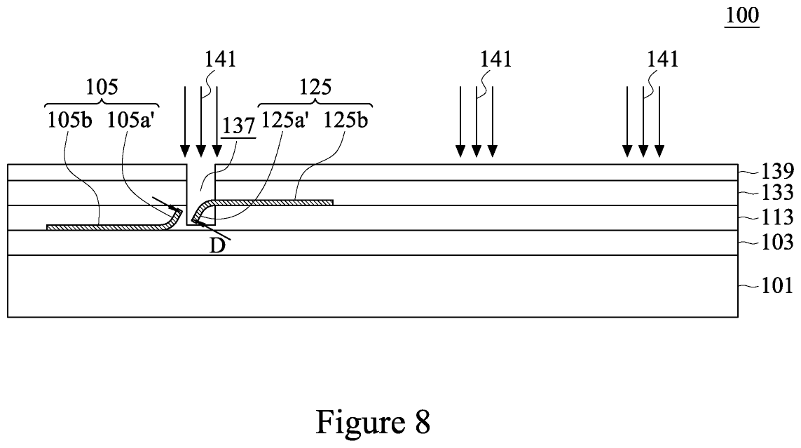

With reference to FIG. 8, after the end portion 125a of the second waveguide 125 is exposed from the recess 137, an implant process 141 is performed on the end portion 125a of the second waveguide 125, in accordance with some embodiments. The first waveguide 105 and other portions of the second waveguide 125 may be masked by the mask layer 139 while performing the implant process 141. The implant process 141 may include implanting second implant species into the end portion 125a of the second waveguide 125. The second implant species may include nitrogen ions (N⁺), silicon ions (Si⁺), other suitable ion implants, or a combination thereof. The second implant species may be delivered using an ion beam having a dose from about 1×10¹⁴ atoms/cm² to about 1×10¹⁶ atoms/cm², with implant energy from about 10 keV to about 50 keV at a temperature of about −30 degrees Celsius to about 200 degrees Celsius. An anneal process may not be needed after the implant process 141.

The depth of the peak concentration in the end portion 125a of the second waveguide 125 may be well-controlled by the implant process 141. For example, the peak concentration of second implant species is in the upper half of the end portion 125a of the second waveguide 125, or in the top one-third of the end portion 125a of the second waveguide 125. Alternatively, the concentration of the second implant species in the upper half of the end portion 125a of the second waveguide 125 is greater than the concentration of the second implant species in the lower half of the end portion 125a. Accordingly, a compressive stress is generated toward the lower half of the second waveguide 125. The end portion 125a of the second waveguide 125 is bent downwardly from the major portion 125b and becomes a bent portion 125a′. In some embodiments, the bent portion 125a′ has a curved shape. The bent portion 125a′ of the second waveguide 125 may extend vertically below a half of the thickness between a bottom surface of a major portion 125b of a second waveguide 125 and a top surface of the major portion 105b of the first waveguide 105. The mask layer 139 for forming the recess 137 may be removed after the implant process 141 is performed by any suitable methods, such as by an etch process.

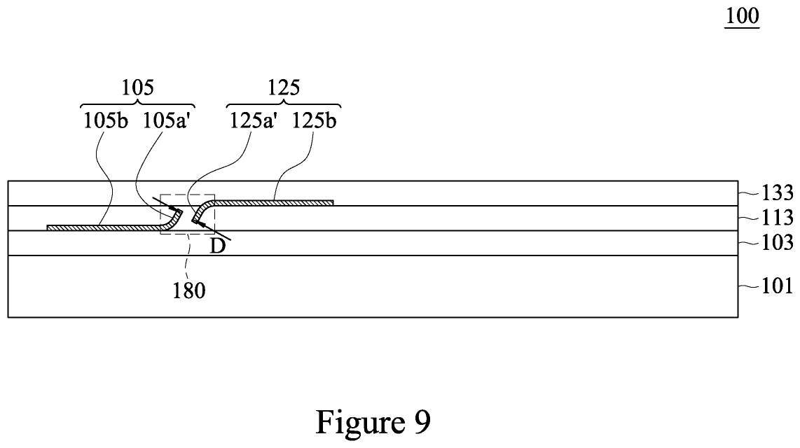

With reference to FIG. 9, after the bent portion 125a′ of the second waveguide 125 has been formed, a deposition process is performed to fill the recess 137, in accordance with some embodiments. The deposition process may provide a material that is the same as the third insulating layer 133 and the second insulating layer 113. Therefore, the third insulating layer 133 after the refill may encapsulate the bent portion 125a′ of the second waveguide 125. The deposition process may include a deposition method such as a plasma enhanced chemical vapor deposition, other chemical vapor deposition processes, physical vapor deposition, combinations of these, or the like. In some embodiments, the mask layer 139 is removed after the deposition process for filling the recess 137 if it is not removed right after the implant process 141. A planarization process such as chemical mechanical polishing (CMP) or mechanical grinding may be optionally performed following the deposition to remove excess materials over the third insulating layer 133.

Because the bent portion 105a′ of the first waveguide 105 is bent upwardly, and the bent portion 125a′ of the second waveguide 125a is bent downwardly, the bent portion 105a′ of the first waveguide 105 and the bent portion 125a′ of the second waveguide 125 may become close to each other, or even overlap each other in a vertical direction. For example, the bent portion 125a′ of the second waveguide 125 and bent portion 105a′ of the first waveguide 105 may have a distance D smaller than about 1 μm. Accordingly, the bent portion 105a′ of the first waveguide 105 and the bent portion 125a′ of the second waveguide 125a may form a coupler 180. The coupler 180 may be an inter-layer coupler that provides a vertical interconnection for waveguides in different levels (e.g., in different insulating layers). For example, the first waveguide 105 and the second waveguide 125 can transmit optical signals to each other via the coupler 180. By forming bent portions of waveguides, the optical interconnect structure 100 can provide vertical optical interconnect. While major portions of the waveguides can still provide horizontal optical interconnect, a highly integrated optical interconnect structure 100 can be provided.

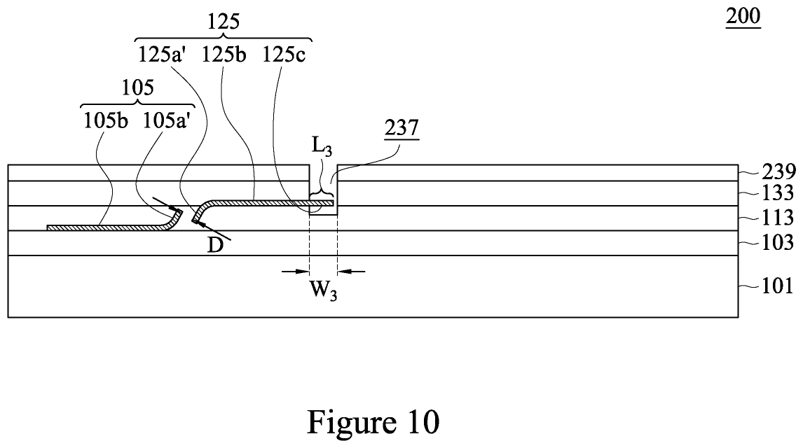

FIGS. 10 to 14 illustrate cross-sectional views of intermediate stages in the manufacturing of an optical interconnect structure 200, in accordance with some embodiments. The optical interconnect structure 200 may be formed using similar processing steps for the optical interconnect structure 100, where similar referencing numerals represent similar features. In particular, the processing illustrated in FIG. 10 assumes the processing illustrated in FIGS. 1 to 9 was performed prior. In some embodiments, the waveguide in the optical interconnect structure 200 includes a plurality of bent portions that allow the waveguides to form couplers with waveguides in a lower level, in an upper level, or a combination thereof.

With reference to FIG. 10, a recess 237 may be formed to expose another end of the second waveguide 125, such as the end portion 125c of the second waveguide 125. In some embodiments, the end portion 125c of the second waveguide 125 has a length L₃. The length L₃ may be greater than a half of the thickness of the third insulating layer 133, or may be equal or greater than the thickness of the third insulating layer 133. For example, the length L₃ may be about 1 μm to about 30 μm. The recess 237 may have a width W₃ greater than the length L₃ and extend to a depth deeper than the bottom of the second waveguide 125 to allow the end portion 125c of the second waveguide 125 to be free to move in subsequent processes. The end portion 125c of the second waveguide 125 may hang in the recess 237.

In some embodiments, the recess 237 may be formed by etching the third insulating layer 133 and the second insulating layer 113 according to a pattern of a mask layer 239. In an embodiment the mask layer 239 may be formed using similar materials and methods of formation as the mask layer 119 described above. However, any suitable materials and methods of manufacturing may be utilized. The etch process for forming the recess 237 may include a wet etch process or a combination of a dry etch process followed by a wet etch process, with using an etchant comprising fluorine (e.g., HF, CF₃, C₂F₂, or the like). The etch process may have a high selectivity for the third insulating layer 133 and the second insulating layer 113 relatively to the second waveguide 125.

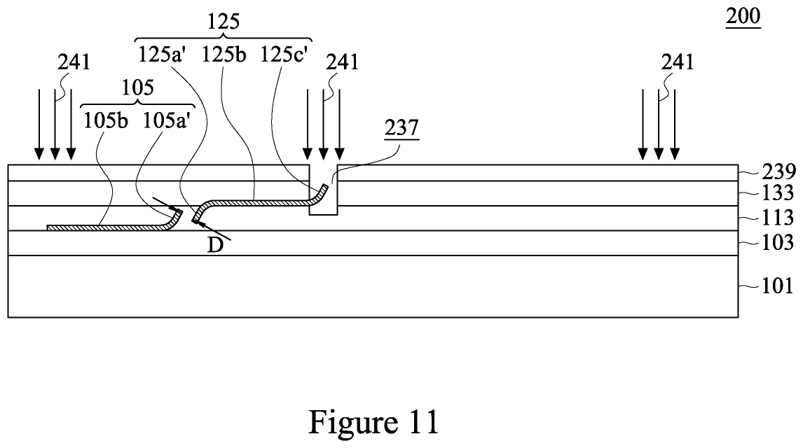

With reference to FIG. 11, after the end portion 125c of the second waveguide 125 is exposed from the recess 237, an implant process 241 is performed on the end portion 125c of the second waveguide 125, in accordance with some embodiments. The implant process 241 may include implanting third implant species into the end portion 125c of the second waveguide 125. The third implant species may include nitrogen ions (N⁺), silicon ions (Si⁺), other suitable ion implants, or a combination thereof. The third implant species may be delivered using an ion beam having a dose from about 1×10¹⁴ atoms/cm² to about 1×10¹⁶ atoms/cm², with implant energy from about 100 keV to about 150 keV at a temperature of about −30 degrees Celsius to about 200 degrees Celsius. An anneal process may not be needed after the implant process 241.

The depth of the peak concentration of the third implant species in the end portion 125c of the second waveguide 125 may be well-controlled by the implant process 241. For example, the peak concentration of the third implant species is in the lower half of the end portion 125c of the second waveguide 125, or in the bottom one-third of the end portion 125c of the second waveguide 125. Alternatively, a concentration of the third implant species in the lower half of the end portion 125c of the second waveguide 125 is greater than a concentration of the third implant species in the upper half of the end portion 125c. Accordingly, a compressive stress is generated toward the upper half of the end portion 125c of the second waveguide 125. The end portion 125c of the second waveguide 125 is bent upwardly from the major portion 125b and becomes a bent portion 125c′. In some embodiments, the bent portion 125c′ has a curved shape. The bent portion 125c′ of the second waveguide 125 may extend vertically above a half of a thickness between the upper surface of the third insulating layer 133 and the upper surface of the major portion 125b of the second waveguide 125. The mask layer 239 for forming the recess 237 may be removed after the implant process 241 is performed by any suitable methods, such as an etch process.

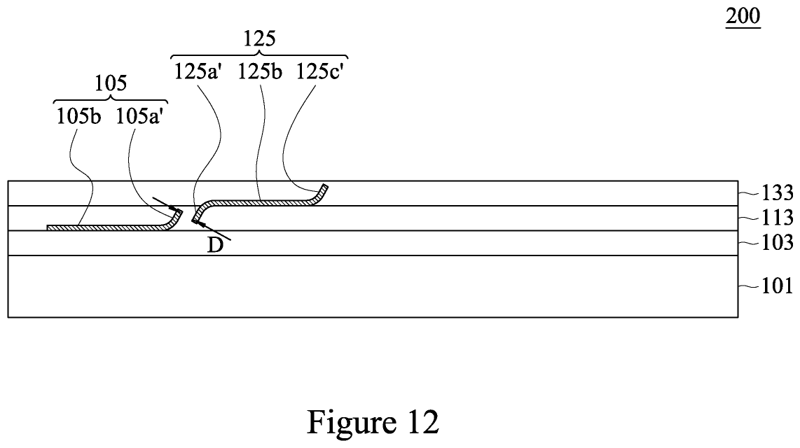

With reference to FIG. 12, after the bent portion 125c′ of the second waveguide 125 has been formed, a deposition process is performed to fill the recess 237, in accordance with some embodiments. The deposition process may provide a material that is the same as the third insulating layer 133. Therefore, the third insulating layer 133 after the refill may encapsulate the bent portion 125c′ of the second waveguide 125. For example, the deposition process may include a deposition method such as a plasma enhanced chemical vapor deposition, other chemical vapor deposition processes, physical vapor deposition, combinations of these, or the like. In some embodiments, the mask layer 239 is removed after the deposition process for filling the recess 237 if the mask layer 239 is not removed right after the implant process 241. A planarization process such as CMP or mechanical grinding may be optionally performed following the deposition to remove excess materials over the third insulating layer 133.

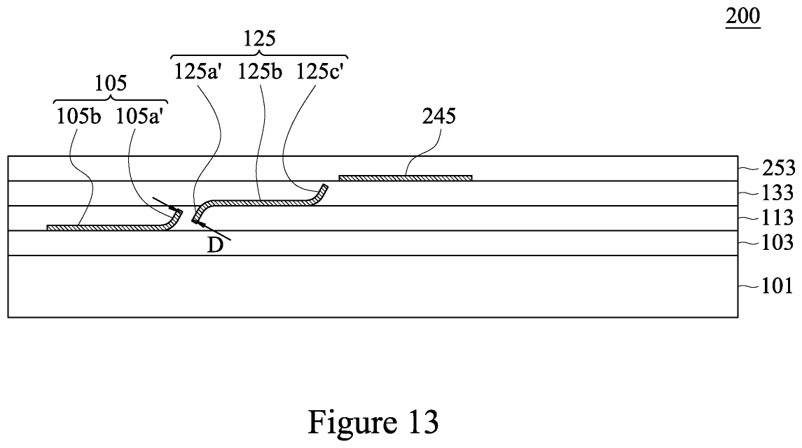

With reference to FIG. 13, a third waveguide 245 may be formed over the third insulating layer 133. In an embodiment the third waveguide 245 may be formed using similar materials and similar methods of manufacture as the first waveguide 105 described above such as depositing a material such as silicon nitride using chemical vapor deposition. However, any suitable materials and methods of manufacturing may be utilized. In some embodiments, the third waveguide 245 may have an end adjacent to the bent portion 125c′ of the second waveguide 125. In some embodiments, the third waveguide 245 has a horizontal gap (greater than 0) with the bent portion 125 c′ of the second waveguide 125. In some embodiments, the third waveguide 245 includes a narrowed width of between about 1 nm and about 200 nm. For example, the third waveguide 245 includes a gradually narrowed width toward the end of the third waveguide 245 adjacent to the second waveguide 125.

After the third waveguide 245 has been formed, a fourth insulating layer 253 may be formed over the third waveguide 245. In an embodiment the fourth insulating layer 253 may be formed using similar materials and methods of formation as the first insulating layer 103 described above, such as depositing a material such as silicon oxide using a deposition method such as a low temperature plasma enhanced chemical vapor deposition. However, any suitable materials and methods of manufacturing may be utilized.

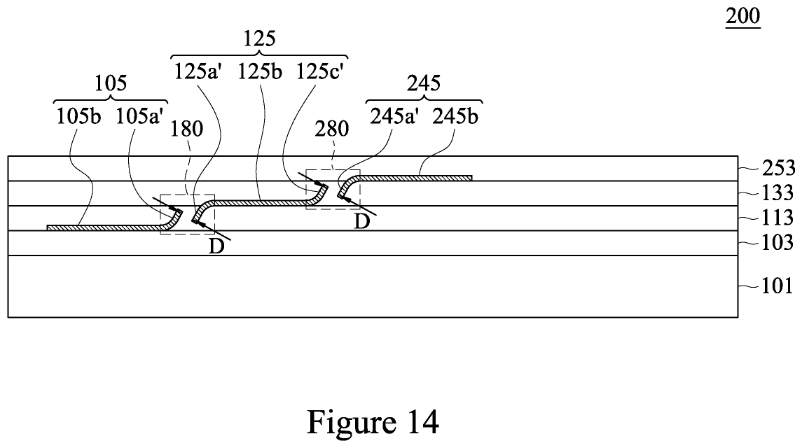

With reference to FIG. 14, manufacturing steps similar to the steps described with reference to FIGS. 7 to 9 are performed, in accordance with some embodiments. For example, an implant process is applied to an end of the third waveguide 245 to form a bent portion 245a′. The bent portion 245a′ may extend downwardly from a major portion 245b of the third waveguide 245. Because the bent portion 125c′ of the second waveguide 125 is bent upwardly, and the bent portion 245a′ of the third waveguide 245 is bent downwardly, the bent portion 125c′ of the second waveguide 125 and the bent portion 245a′ of the third waveguide 245 may become close to each other, or even overlap each other in the vertical direction. For example, the bent portion 125c′ of the second waveguide 125 and the bent portion 245a′ of the third waveguide 245 may have a distance smaller than or equal to the distance D. Accordingly, the bent portion 125c′ of the second waveguide 125 and the bent portion 245a′ of the third waveguide 245a may form a coupler 280. The coupler 280 may be an inter-layer coupler that provides vertical interconnection for waveguides in different levels (e.g., in different insulating layers). For example, the third waveguide 245 and the second waveguide 125 can transmit optical signals to each other via the coupler 280. The third waveguide 245 may further communicate with the first waveguide 105 via the second waveguide 125 and the couplers 180 and 280. Also, not only the second waveguide can have a plurality of bent portions, but other waveguides at any level can have a plurality of bent portions that are either bent upwardly or downwardly. As such, any number of couplers can be formed in the optical interconnect structure 200, and a highly integrated optical interconnect structure 200 can be provided.

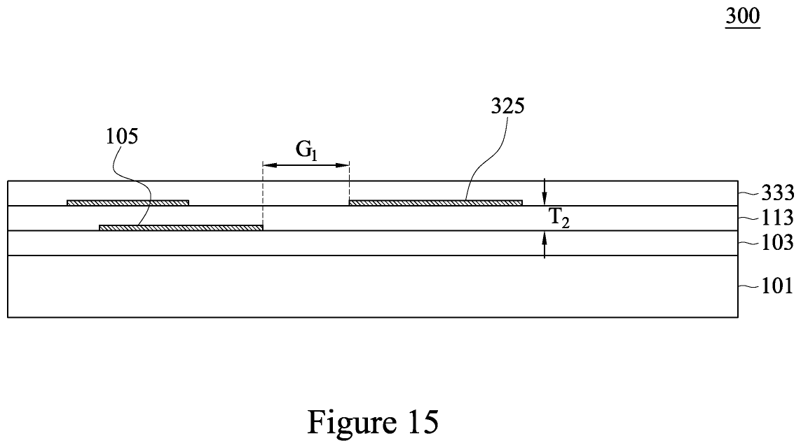

FIGS. 15 to 21 illustrate cross-sectional views of intermediate stages in the manufacturing of an optical interconnect structure 300, in accordance with some embodiments. The optical interconnect structure 300 may be formed using similar processing steps for the optical interconnect structure 100, where similar referencing numerals represent similar features. In particular, the processing illustrated in FIG. 15 assumes the processing illustrated in FIGS. 1 to 2 was performed prior. In some embodiments of the optical interconnect structure 300, a coupler across more than one insulating layer is provided.

With reference to FIG. 15, a second waveguide 325 may be formed over the second insulating layer 113. In an embodiment the second waveguide 325 may be formed using similar materials and similar methods of manufacture as the first waveguide 105 described above such as depositing a material such as silicon nitride using chemical vapor deposition. However, any suitable materials and methods of manufacturing may be utilized. The second waveguide 325 may have a horizontal gap G₁ with the first waveguide 105. In some embodiments, the gap G₁ is greater than the length L₁ and the distance D described above. For example, the gap G₁ may be about 2 μm to about 100 μm.

After the second waveguide 325 has been formed, a third insulating layer 333 may be formed over the second waveguide 325. In an embodiment the third insulating layer 333 may be formed using similar materials and methods of formation as the first insulating layer 103 described above, such as depositing a material such as silicon oxide using a deposition method such as a low temperature plasma enhanced chemical vapor deposition. However, any suitable materials and methods of manufacturing may be utilized.

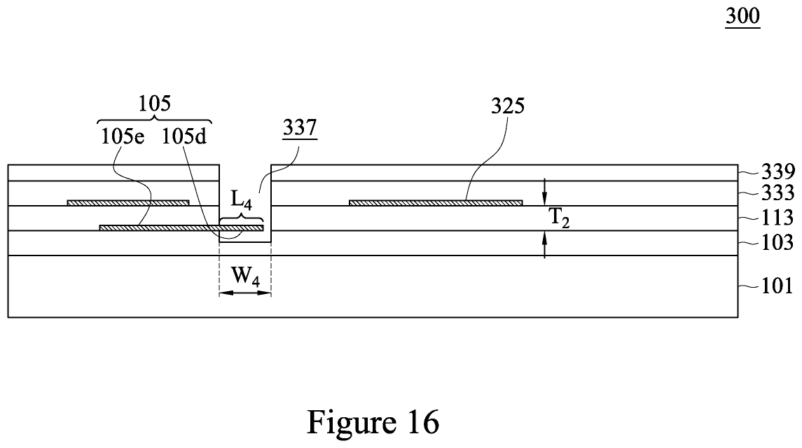

With reference to FIG. 16, after the second waveguide 325 and the third insulating layer 333 have been formed, a recess 337 is formed to expose an end portion 105d of the first waveguide 105. A major portion 105e of the first waveguide 105 remains covered by the second insulating layer 113. In some embodiments, the end portion 105d of the first waveguide 105 has a length L₄. The length L₄ may be greater than a thickness T₂ of the second insulating layer 113, or may be equal to or greater than two times the thickness T₂ of the second insulating layer 113. For example, the length L₄ may be about 1 μm to about 30 μm. The recess 337 may have a width W₄ greater than the length L₄ and extend to a depth deeper than the bottom of the first waveguide 105 to allow the end portion 105d of the first waveguide 105 to be free to move in subsequent processes. The end portion 105d of the first waveguide 105 may hang in the recess 337.

In some embodiments, the recess 337 may be formed by etching the third insulating layer 333, the second insulating layer 113, and the first insulating layer 103 according to a pattern of a mask layer 339. For example, the formation of the mask layer 339 may include depositing a mask material over the third insulating layer 333 by any suitable deposition process and patterning the mask material to form the pattern in the mask layer 339 by any suitable patterning processes. The mask layer 339 may be a hard mask such as titanium nitride, silicon nitride, silicon oxynitride, silicon carbide, other suitable materials, or a combination thereof. Alternatively, the mask layer 339 may be a photoresist material. The etch process for forming the recess 337 may include a wet etch process or a combination of a dry etch process followed by a wet etch process, with using an etchant comprising fluorine (e.g., HF, CF₃, C₂F₂, or the like). The etch process may have a high selectivity for the second insulating layer 113 and the first insulating layer 103 relatively to the first waveguide 105.

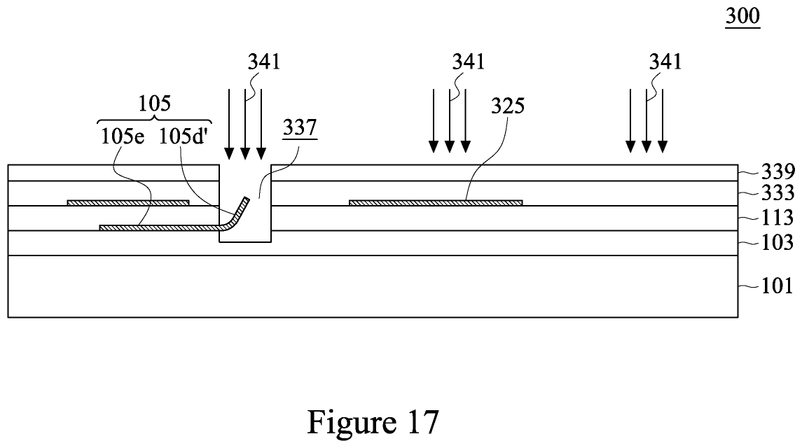

With reference to FIG. 17, after the recess 337 has been formed, an implant process 341 is performed on the end portion 105d of the first waveguide 105. Other portions of the first waveguide 105 and the second waveguide 325 are masked by the mask layer 339 while performing the implant process 341. The implant process 341 may include implanting fifth implant species into the end portion 105d of the first waveguide 105. The fifth implant species may include nitrogen ions (N⁺), silicon ions (Si⁺), other suitable ion implants, or a combination thereof. The fifth implant species may be delivered using an ion beam having a dose from about 1×10¹⁴ atoms/cm² to about 1×10¹⁶ atoms/cm², with an energy from about 100 keV to about 150 keV at a temperature of about −30 degrees Celsius to about 200 degrees Celsius. An anneal process may not be needed after the implant process 341.

The depth of the peak concentration in the end portion 105d of the first waveguide 105 may be well-controlled by the implant process 341. For example, the peak concentration of the fifth implant species is in the lower half of the end portion 105d of the first waveguide 105, or in the bottom one-third of the first waveguide 105. Alternatively, a concentration of the fifth implant species in the lower half of the end portion 105d of the first waveguide 105 is greater than a concentration of the second implant species in the upper half of the end portion 105d. Accordingly, a compressive stress is generated toward the upper half of the end portion of 105d of the first waveguide 105. The end portion 105d of the first waveguide 105 is bent upwardly from the major portion 105e and becomes a bent portion 105d′. In some embodiments, the bent portion 105d′ has a curved shape. In some embodiments, the bent portion 105d′ of the first waveguide 105 protrudes over the second insulating layer 113, such as vertically overlapping the second waveguide 325. The mask layer 339 may be removed after the implant process 341 is performed by any suitable methods, such as an etch process.

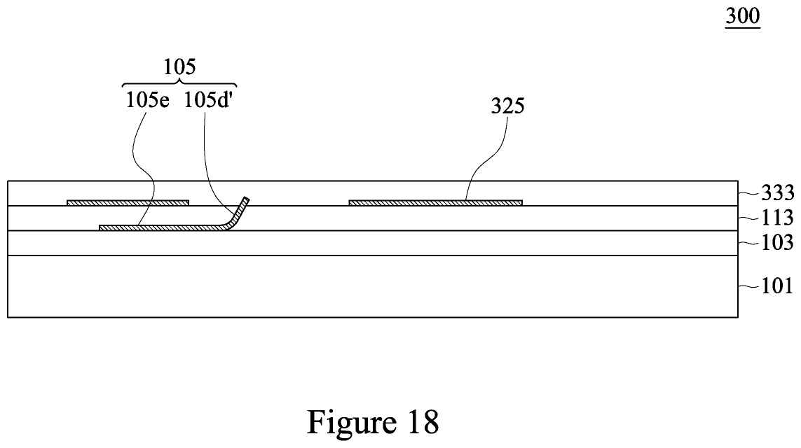

With reference to FIG. 18, after the bent portion 105d′ of the first waveguide 105 has been formed, a deposition process is performed to fill the recess 337 and encapsulate the bent portion 105d′ of the first waveguide 105, in accordance with some embodiments. The deposition process may provide a material that is the same as the first insulating layer 103, the second insulating layer 113, and the third insulating layer 333. For example, the deposition process may include a deposition method such as a plasma enhanced chemical vapor deposition, other chemical vapor deposition processes, physical vapor deposition, combinations of these, or the like. A planarization process such as CMP or mechanical grinding may be optionally performed following the deposition to remove excess materials over the third insulating layer 333. In some embodiments, the mask layer 339 is removed after the planarization process is performed if it is not removed before the deposition process for filling the recess 337.

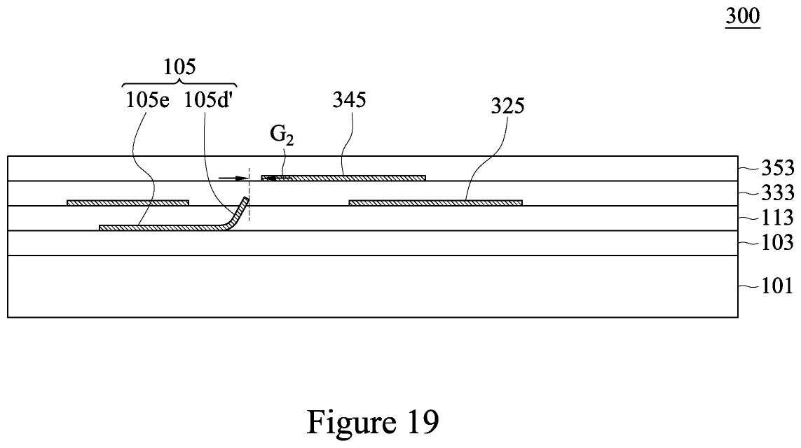

With reference to FIG. 19, after the recess 337 is filled, a third waveguide 345 is formed over the second insulating layer 113, and a fourth insulating layer 353 is formed over the third waveguide 345 and the third insulating layer 333, in accordance with some embodiments. In an embodiment the third waveguide 345 may be formed using similar materials and similar methods of manufacture as the first waveguide 105 described above such as depositing a material such as silicon nitride using chemical vapor deposition. However, any suitable materials and methods of manufacturing may be utilized. In some embodiments, the third waveguide 345 has an end adjacent to the bent portion 105d′ of the first waveguide 105, such as having a horizontal gap G₂ with the bent portion 105d′ of the first waveguide 105. The gap G₂ is smaller than the gap G₁. For example, the gap G₂ may be 0.1 μm to 0.9 μm. In an embodiment the fourth insulating layer 353 may be formed using similar materials and methods of formation as the first insulating layer 103 described above, such as depositing a material such as silicon oxide using a deposition method such as a low temperature plasma enhanced chemical vapor deposition.

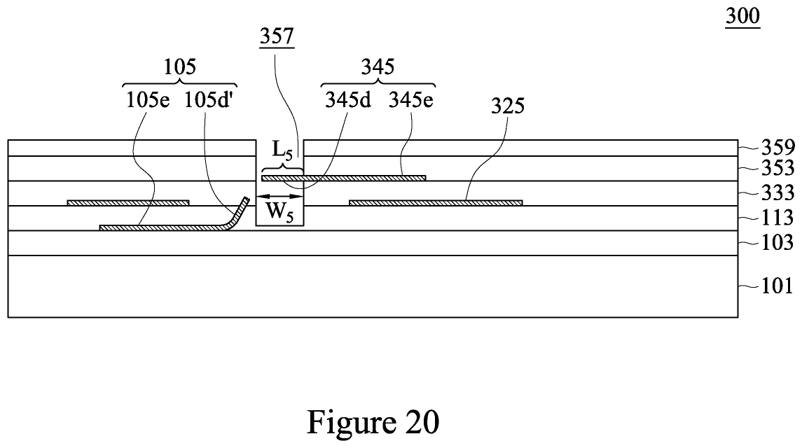

With reference to FIG. 20, after the third waveguide 345 and the fourth insulating layer 353 have been formed, a recess 357 is formed to expose an end portion 345d of the third waveguide 345. A major portion 345e of the third waveguide 345 remains covered by the fourth insulating layer 353. In some embodiments, the end portion 345d of the first waveguide 345 has a length L₅. The length L₅ may be greater than a thickness of the third insulating layer 333, or may be equal or greater than two times the thickness of the third insulating layer 333. For example, the length L₅ may be about 1 μm to about 30 μm. The length L₅ may be the same as the length L₄ although they may be different. The recess 357 may have a width W₅ greater than the length L₄ and extend into or through the second insulating layer 113. In some embodiments, the depth of recess 357 measured from the upper surface of the third insulating layer 333 is greater than the length L₅. The end portion 345d of the third waveguide 345 may hang in the recess 357.

The recess 357 may be formed by etching the fourth insulating layer 353, the third insulating layer 333, and the second insulating layer 113 according to a pattern of a mask layer 359. For example, the formation of the mask layer 359 may include depositing a mask material over the fourth insulating layer 353 by any suitable deposition process and patterning the mask material to form the pattern in the mask layer 359 by any suitable patterning processes. The mask layer 359 may be a hard mask such as titanium nitride, silicon nitride, silicon oxynitride, silicon carbide, other suitable materials, or a combination thereof. Alternatively, the mask layer may be a photoresist material. The etch process for forming the recess 357 may include a wet etch process or a combination of a dry etch process followed by a wet etch process, with using an etchant comprising fluorine (e.g., HF, CF₃, C₂F₂, or the like). The etch process may have a high selectivity for the fourth insulating layer 353 and the third insulating layer 333 relatively to the third waveguide 345.

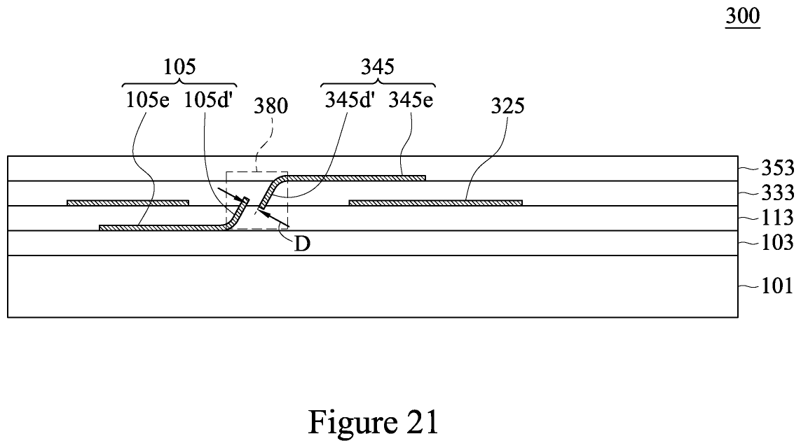

With reference to FIG. 21, after recess 357 has been formed, an implant process is performed on the end portion 345d of the third waveguide 345. The first waveguide 105, the second waveguide 325, and other portions of the third waveguide 345 are masked by the mask layer 359 while performing the implant process. The implant process may include implanting sixth implant species into the end portion 345d of the third waveguide 345. The sixth implant species may include nitrogen ions (N⁺), silicon ions (Si⁺), other suitable dopants, or a combination thereof. The sixth implant species may be delivered using an ion beam having a dose from about 1×10¹⁴ atoms/cm² to about 1×10¹⁶ atoms/cm², with an implant energy from about 10 keV to about 50 keV at a temperature of about −50 degrees Celsius to about 200 degrees Celsius. An anneal process may not be needed after the implant process.

The depth of the peak concentration in the end portion 345d of the third waveguide 345 may be well-controlled by the implant process. For example, the peak concentration of the sixth implant species is in the upper half of the end portion 345d of the third waveguide 345, or in the top one-third of the end portion 345d of the third waveguide 345. Alternatively, the concentration of the sixth implant species in the upper half of the end portion 345d of the third waveguide 345 is greater than the concentration of the sixth implant species in the lower half of the end portion 345d of the third waveguide 345. Accordingly, a compressive stress is generated toward the lower half of the end portion 345d of the third waveguide 345. The end portion 345d of the third waveguide 345 is bent downwardly form the major portion 345e and becomes a bent portion 345d′. In some embodiments, the bent portion 345d′ of the third waveguide 345 has a curved shape. The mask layer 359 for forming the recess 357 may be removed after the implant process is performed by any suitable processes, such as an etch process.

Because the bent portion 105d′ of the first waveguide 105 is bent upwardly, and the bent portion 345d′ of the third waveguide 345 is bent downwardly, the bent portion 345d′ of the third waveguide 345 and the bent portion 105d′ of the first waveguide 105 may be close to each other, or even overlap each other in a vertical direction. For example, the bent portion 345d′ and the bent portion 105d′ may have a distance smaller than or equal to the distance D. As such, the bent portion 105d′ of the first waveguide 105 and the bent portion 345d′ of the third waveguide 345 may form a coupler 380. The coupler 380 may be an inter-layer coupler that provides a vertical interconnection for waveguides at different levels. In particular, the coupler 380 can couple waveguides not only in adjacent levels. For example, the coupler 380 can cross two or more insulating layers (e.g., the second insulating layer 113 and the third insulating layer 333) to couple the first waveguide 105 in the second insulating layer 113 and the third waveguide 345 in the fourth insulating layer 353. In some embodiments, a waveguide in an intermediate level (e.g., the second waveguide 325) is located vertically between the major portion 105e of the first waveguide 105 and the major portion 345e of the third waveguide 345. The existence of the second waveguide 325 would not cause a cross-talk problem with the first waveguide 105 or the third waveguide 345 because a sufficient vertical distance (e.g., a distance equal to thickness T₃) is provided.

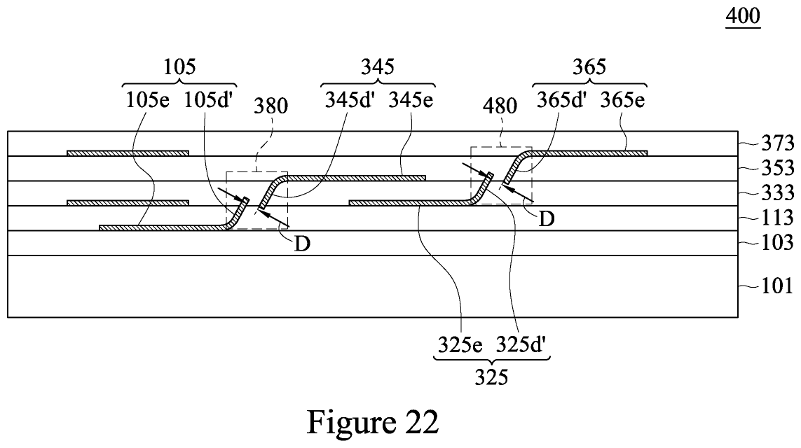

FIG. 22 illustrates a cross-sectional view of an intermediate stage of an optical interconnect structure 400, in accordance with some embodiments. The optical interconnect structure 400 may be formed using similar processing steps for the optical interconnect structures 300, where similar referencing numerals represent similar features. In some embodiments of the optical interconnect structure 400, the second waveguide 325 in an intermediate level adjacent to the coupler 380 may also form a coupler with a higher level of waveguide, such as a fourth waveguide 365, for providing vertical optical interconnections. For example, an implant process may be performed on an end portion of the second waveguide 325 to form a bent portion 325d′ that extends upwardly from a major portion 325e of the second waveguide 325. The fourth waveguide 365 and a fifth insulating layer 373 may be formed over the fourth insulating layer 353. The fourth waveguide 365, the bent portion 365d′ of the waveguide 365 and the fifth insulating layer 373 may be formed using similar steps described with reference to FIGS. 19 to 21.

Because the bent portion 325d′ of the second waveguide 325 is bent upwardly, and the bent portion 365d′ of the fourth waveguide 365 is bent downwardly, the bent portion 325d′ and the bent portion 365d′ may be close to each other, or even overlap each other in a vertical direction. The bent portion 325d′ of the second waveguide 325 and the bent portion 365d′ of the fourth waveguide 365 may form a coupler 480. In some embodiments, the third waveguide 345 would not cause cross-talk with the second waveguide 325 or the fourth waveguide 365 because a sufficient vertical distance (e.g., a distance equal to thickness T₃) is provided. Although only four levels of waveguides and two couplers are illustrated in FIG. 22, these embodiments are not intended to be limiting, more couplers and more levels of waveguides may be applied in the optical interconnect structure 400.

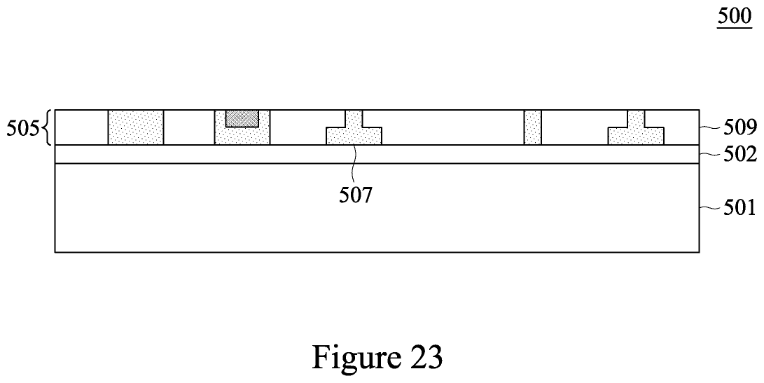

In some embodiments, a cross-sectional view of an intermediate structure of a photonic integrated circuit (PIC) 500 is illustrated. The PIC 500 may include electrical interconnects integrated with any of the optical interconnect structures 100, 200, 300, or 400 described in previous embodiments or any of their combinations. For example, FIGS. 23 to 25 illustrate intermediate stages of a PIC with an integration of the optical interconnect structure 100 and electrical interconnects.

Starting with FIG. 23, a substrate 501 similar with the substrate 101 described above is provided. An intermediate insulating layer 502 and an active layer 505 may be disposed over and supported by the substrate 501. In some embodiments, the substrate 501, the intermediate insulating layer 502 and the active layer 505 may collectively be part of a silicon-on-insulator (SOI) substrate at a beginning of the manufacturing process. In some embodiments, the active layer 505 (after formation) includes one or more optical components 507. The intermediate insulating layer 502 may be a dielectric layer that separates the substrate 501 from the overlying active layer 505 and can additionally, in some embodiments, serve as a portion of cladding material that surrounds the optical components 507 in the active layer 505. In an embodiment the intermediate insulating layer 502 may be silicon oxide, silicon nitride, germanium oxide, germanium nitride, combinations of these, or the like, formed using a method such as implantation (e.g., to form a buried oxide (BOX) layer) or else may be deposited onto the substrate 501 using a deposition method such as chemical vapor deposition, atomic layer deposition, physical vapor deposition, combinations of these, or the like. However, any suitable material and method of manufacture may be used.

The optical components 507 in the active layer 505 may include components such as optical waveguides (e.g., ridge waveguides, rib waveguides, buried channel waveguides, diffused waveguides, etc.), couplers (e.g., grating couplers), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. In an embodiment the material for the active layer 505 may be a translucent material that can be used as a core material for the desired optical components 507, such as a semiconductor material such as silicon, germanium, silicon germanium, combinations of these, or the like, while in other embodiments the material for the active layer 505 may be a dielectric material such as silicon nitride or the like, although in other embodiments the material for the active layer 505 may be III-V materials, lithium niobate materials, or polymers. The material may be patterned into the desired shapes for the various optical components.

Once the optical components 507 of the active layer 505 have been formed, a first insulating layer 509 may be deposited to cover the optical components 507. In an embodiment the first insulating layer 509 may be a dielectric layer that separates the individual components of the active layer 505 from each other and from the overlying structures and can additionally serve as another portion of cladding material that surrounds the optical components 507. In an embodiment the first insulating layer 509 may be formed by depositing a material such as silicon oxide using a deposition method such as a low temperature plasma enhanced chemical vapor deposition. However, any suitable materials and methods of manufacturing may be utilized.

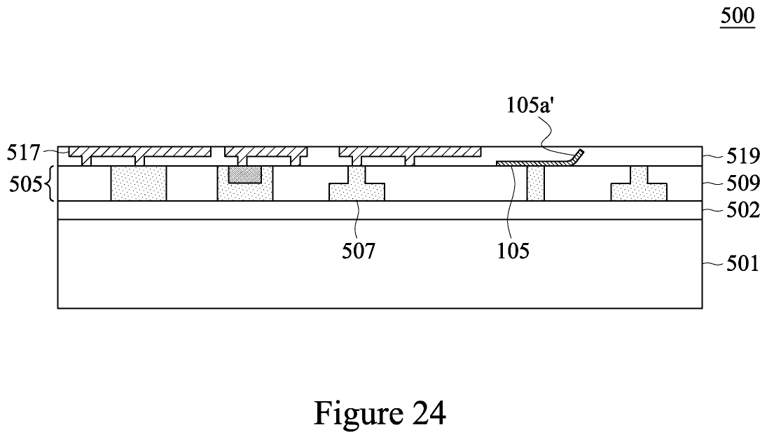

With reference to FIG. 24, the first waveguide 105 with a bent portion 105a′ and first metallization features 517 are provided over the first insulating layer 509. In some embodiments, a patterned material of the first waveguide 105 is formed over the first insulating layer 509, and a second insulating layer 519 is formed over the material of the first waveguide 105. Similar to the steps described with reference FIGS. 3 to 5, the bent portion 105a′ is formed by forming a recess to expose an end portion of the first waveguide 105 and applying an implant process on the end portion of the first waveguide 105. The recess for exposing the end portion of the first waveguide 105 may be refilled with the material of the second insulating layer 519. The first metallization features 517 may be formed in the second insulating layer in order to electrically connect the optical components 507 of the active layer 505 to control circuitry, to each other, and to any devices attached to the PIC 500. The first metallization features 517 may be formed by any suitable methods, such as by single or dual damascene processes after the second insulating layer 519 is formed. In some embodiments, the first metallization features 517 may be formed prior to forming the bent portion 105a′ of the first waveguide 105. In such embodiments, the first metallization features 517 may be masked by a mask layer such as the mask layer 119 while performing the steps for forming the bent portion 105a′. Alternatively, the bent portion 105a′ of the first waveguide 105 may be formed prior to forming the first metallization features 517. In such embodiments, the bent portion 105a′ is masked by a mask layer while performing any etching steps in forming the first metallization features 517 in the second insulating layer 519.

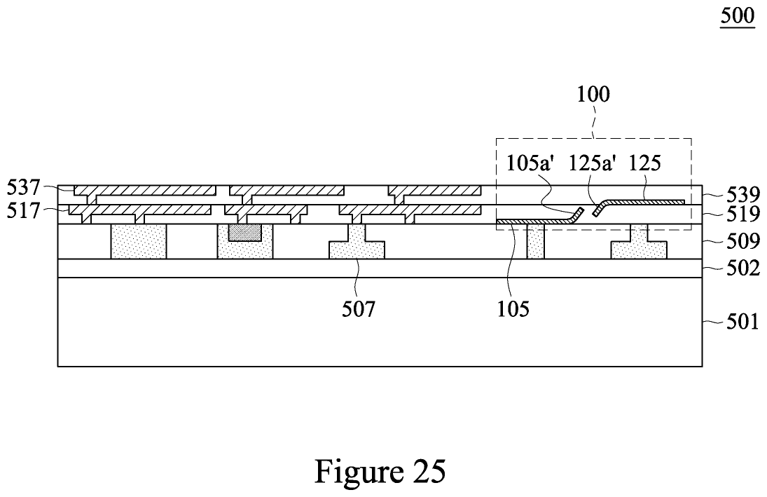

With reference to FIG. 25, one more level of electrical interconnect and one more level of optical interconnect are provided in the PIC 500, in accordance with some embodiments. For example, the second waveguide 125 with a bent portion 125a′ and second metallization features 537 are provided over the second insulating layer 519. In some embodiments, the second waveguide 125 is formed over the first insulating layer 509, and a third insulating layer 539 is formed over the second waveguide 125. Similar to the steps described with reference to FIGS. 7 to 9, the bent portion 125a′ of the second waveguide 125 is formed by forming a recess to expose an end portion of the second waveguide 125 and applying an implant process on the end portion of the second waveguide 125. The recess for exposing the end portion of the second waveguide 125 may be refilled with the material of the third insulating layer 539. The second metallization features 537 may be formed in the third insulating layer 539 and in contact with the first metallization features 517 in order to electrically connect the first metallization features 517. Not only the metallization features 517 and 537 can provide vertical interconnect, the first waveguide 105 and the second waveguide 125 can provide vertical optical interconnection via a coupler formed of the bent portion 105a′ and the bent portion 125a′.

The second metallization features 537 may be formed by any suitable methods, such as by single or dual damascene processes, after the third insulating layer 539 is formed. In some embodiments, the second metallization features 537 may be formed prior to forming the bent portion 125a′ of the second waveguide. In such embodiments, the second metallization features 537 may be masked by a mask layer such as the mask layer 139 while performing the steps for forming the bent portion 125a′. Alternatively, the bent portion 125a′ of the second waveguide 125 may be formed prior to forming the second metallization features 537. In such embodiments, the bent portion 125a′ is masked by a mask layer while performing any etching steps in forming the second metallization features 537 in the third insulating layer 539.

Accordingly, the PIC 500 may provide an integration of electrical interconnect (e.g., the first metallization features 517 and the second metallization features 537) and optical interconnect (e.g., the optical interconnect structure 100). For example, the optical interconnect structure 100 in the PIC 500 may include a coupler functioning like conductive vias of the electrical interconnect for inter-layer signal transmission. The electrical interconnect and the optical interconnect may share the same insulating layers. Accordingly, the complexities of routing design for the electrical interconnect and the optical interconnect can be reduced. Furthermore, because the process for manufacturing the optical interconnect may be independent of the electrical interconnect, manufacturing the optical interconnect may be compatible with various electrical interconnects.

In an embodiment, a method of manufacturing an optical device includes forming a first waveguide in a first insulating layer over a substrate, wherein the first waveguide includes a first major portion and a first bent portion extending upwardly from the first major portion away from the substrate; and forming a second waveguide over the first waveguide, wherein the second waveguide includes a second major portion over the first insulating layer and a second bent portion extending downwardly from the second major portion and into the first insulating layer. In an embodiment, the first bent portion of the first waveguide overlaps the second bent portion of the second waveguide in a vertical direction. In an embodiment, the forming the first waveguide in the first insulating layer includes forming a patterned material of the first waveguide; forming the first insulating layer over the patterned material of the first waveguide; forming a first recess to expose an end portion of the patterned material of the first waveguide, wherein a portion of the first waveguide not exposed by the first recess forms the first major portion of the first waveguide; and forming the first bent portion of the first waveguide by implanting first implant species into the end portion of the patterned material of the first waveguide. In an embodiment, the first implant species has a peak concentration in a lower half of the first bent portion of the first waveguide. In an embodiment, the method further includes filling a material of the first insulating layer into the first recess after the forming the first bent portion of the first waveguide. In an embodiment, the forming the second waveguide includes forming a patterned material of the second waveguide over the first insulating layer; forming a second insulating layer over the patterned material of the second waveguide; forming a second recess in the second insulating layer and the first insulating layer to expose a second end portion of the second waveguide, wherein a portion of the second waveguide not exposed by the second recess forms the second major portion of the second waveguide; and forming the second bent portion of the second waveguide by implanting second implant species into the second end portion of the patterned material of the second waveguide. In an embodiment, the second implant species has a peak concentration in an upper half of the second bent portion.

In another embodiment, a method of manufacturing an optical device includes forming a first waveguide over a substrate; forming a first insulating layer covering the first waveguide and over the substrate; forming a first recess in the first insulating layer to expose a first end portion of the first waveguide; performing a first implant process on the first end portion of the first waveguide to form a first bent portion of the first waveguide, wherein the first bent portion is bent upwardly with respect to a portion of the first waveguide not exposed from the first recess; forming a second waveguide over the first insulating layer, wherein the second waveguide has a horizontal gap with the first bent portion of the first waveguide; forming a second insulating layer covering the second waveguide and over the first insulating layer; forming a second recess in the second insulating layer and the first insulating layer to expose a second end portion of the second waveguide, the second end portion of the second waveguide being adjacent to the first bent portion of the first waveguide; and performing a second implant process on the second end portion of the second waveguide to form a second bent portion of the second waveguide, wherein the second bent portion is bent downwardly with respect to a portion of the second waveguide not exposed from the second recess. In an embodiment, the first implant process implants first implant species into the first end portion of the first waveguide, the first implant process providing a concentration of the first implant species in a lower half of the first end portion of the first waveguide greater than a concentration of the first implant species in an upper half of the first end portion of the first waveguide after performing the first implant process. In an embodiment, the first implant species includes N⁺, Si⁺, or a combination thereof. In an embodiment, the second implant process includes implanting second implant species into the second end portion of the second waveguide, the second implant process providing a concentration of the second implant species in an upper half of the second end portion of the second waveguide greater than a concentration of the second implant species in a lower half of the second end portion of the second waveguide. In an embodiment, the first implant species and the second implant species are the same, and the first implant process and the second implant process provide different implant energy. In an embodiment, the first recess has a width greater than a length of the first end portion of the first waveguide. In an embodiment, the forming the first recess includes forming a mask layer over the first insulating layer and etching the first insulating layer according to a pattern of the mask layer, and the mask layer is removed after the performing the first implant process.

In yet another embodiment, an optical device includes a first insulating layer over a substrate; a first waveguide in the first insulating layer, wherein the first waveguide includes a first major portion and a first bent portion extending upwardly from the first major portion away from the substrate; and a second waveguide over the first waveguide, wherein the second waveguide includes a second major portion over the first insulating layer and a second bent portion extending downwardly from the second major portion and into the first insulating layer. In an embodiment, the first bent portion of the first waveguide overlaps the second bent portion of the second waveguide in a vertical direction. In an embodiment, the first bent portion of the first waveguide includes first implant species, wherein the first implant species has a peak concentration in a lower half of the first bent portion of the first waveguide. In an embodiment, the first implant species includes N⁺, Si⁺, or a combination thereof. In an embodiment, the second bent portion of the second waveguide includes second implant species, wherein the second implant species has a peak concentration in an upper half of the second bent portion of the second waveguide. In an embodiment, the first major portion of the first waveguide is parallel to the second major portion of the second waveguide.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical device, comprising:
a first insulating layer over a substrate;
a first waveguide in the first insulating layer, wherein the first waveguide comprises a first major portion and a first bent portion extending upwardly from the first major portion away from the substrate; and
a second waveguide over the first waveguide, wherein the second waveguide comprises a second major portion over the first insulating layer and a second bent portion extending downwardly from the second major portion and into the first insulating layer.

2. The optical device of claim 1, wherein the first bent portion of the first waveguide overlaps the second bent portion of the second waveguide in a vertical direction.

3. The optical device of claim 1, wherein the first bent portion of the first waveguide comprises first implant species, wherein the first implant species has a peak concentration in a lower half of the first bent portion of the first waveguide.

4. The optical device of claim 3, wherein the first implant species comprises N⁺, Si⁺, or a combination thereof.

5. The optical device of claim 1, wherein the second bent portion of the second waveguide comprises second implant species, wherein the second implant species has a peak concentration in an upper half of the second bent portion of the second waveguide.

6. The optical device of claim 1, wherein the first major portion of the first waveguide is parallel to the second major portion of the second waveguide.

7. An optical device, comprising:
a substrate;
an insulating layer over the substrate; and
a waveguide in the insulating layer, the waveguide comprising a major portion extending parallel to the substrate and a bent portion extending away from the major portion toward a surface of the insulating layer, wherein the bent portion comprises an implant species having a peak concentration disposed closer to a first side of the bent portion than to a second side of the bent portion, the bent portion curving toward the second side, wherein the first side is opposite the second side.

8. The optical device of claim 7, wherein the first side of the bent portion is a lower side facing the substrate and the second side is an upper side, such that the bent portion curves upwardly away from the substrate.

9. The optical device of claim 7, wherein the peak concentration is disposed in a bottom one-third of the bent portion.

10. The optical device of claim 7, wherein a concentration of the implant species in a lower half of the bent portion is greater than a concentration of the implant species in an upper half of the bent portion.

11. The optical device of claim 7, wherein the implant species comprises nitrogen ions, silicon ions, or a combination thereof.

12. The optical device of claim 7, wherein the bent portion has a curved shape.

13. The optical device of claim 7, wherein a compressive stress in the bent portion is directed toward the second side.

14. An optical device, comprising:
a first waveguide comprising a first bent portion, the first bent portion comprising a first implant species having a concentration in a lower half of the first bent portion different than a concentration in an upper half of the first bent portion; and
a second waveguide over the first waveguide, the second waveguide comprising a second bent portion overlapping the first bent portion, the second bent portion comprising a second implant species having a concentration in an upper half of the second bent portion different than a concentration in a lower half of the second bent portion, wherein the first bent portion and the second bent portion form a coupler configured to transmit an optical signal between the first waveguide and the second waveguide.

15. The optical device of claim 14, wherein the concentration in the lower half of the first bent portion is greater than the concentration in the upper half of the first bent portion.

16. The optical device of claim 14, wherein the concentration in the upper half of the second bent portion is greater than the concentration in the lower half of the second bent portion.

17. The optical device of claim 14, wherein a compressive stress in the first bent portion is directed toward an upper half of the first bent portion, and a compressive stress in the second bent portion is directed toward a lower half of the second bent portion.

18. The optical device of claim 14, wherein each of the first implant species and the second implant species comprises nitrogen ions, silicon ions, or a combination thereof.

19. The optical device of claim 14, wherein the concentration of the first implant species has a peak in a bottom one-third of the first bent portion, and the concentration of the second implant species has a peak in a top one-third of the second bent portion.

20. The optical device of claim 14, wherein each of the first bent portion and the second bent portion has a curved shape.
